(19) United States
(12) Patent Application Publication
(10) Pub. No.: US 2026/0195200 A1
(43) Pub. Date: Jul. 9, 2026

(54) MANAGING OUTPUT MESSAGE QUEUES BY THE OHNOSECOND

(71) Applicant: International Business Machines Corporation, Armonk, NY (US)

(72) Inventors: Mauro Marzorati, Lutz, FL (US); Jeremy R. Fox, Georgetown, TX (US); Tiberiu Suto, Franklin, NY (US); Carolina Garcia Delgado, Zapopan (MX)

(21) Appl. No.: 19/008,964

(22) Filed: Jan. 3, 2025

(51) Int. Cl. G06F 9/54

(52) U.S. Cl. CPC G06F 9/546

(57) ABSTRACT

A computer-implemented method for managing output message queues by an ohnosecond is provided. A number of processor units gather message data and main inputs at a customizable ohnosecond engine. The number of processor units provide the message data and an ohnosecond value from the customizable ohnosecond engine to a message transfer unit. The number of processor units, responsive to the ohnosecond value, send a delayed message comprising the message data from the message transfer unit to an external messaging program. According to other illustrative embodiments, a computer system and computer program product to manage output message queues by an ohnosecond are provided.

### BACKGROUND

This disclosure relates generally to methods, systems and computer program products to manage output message queues by an ohnosecond, and more specifically to user controlled management of output message queues by the ohnosecond.

At a very high level, we have all experienced in life a situation where we wish we could recall, or take back, some utterance we may have made. The solution that every grandmother, parent, teacher or adult gives to younger folks is to “stop and think.” Complicating matters is the inherent desire to keep pace with the stream of consciousness.

There is a coined word the ohnosecond which is loosely defined as the fraction of time between making a mistake and realizing it. An Oh No! Second can be defined as the fraction of a second it takes you to realize you just made a big mistake on the computer. For example, accidentally clicking no when prompted to save the document you spent all day composing. Or, accidentally clicking send on the email you typed to vent your frustration.

### SUMMARY

An ohnosecond can be harnessed to autonomically manage the delay setting in messaging application, which could be an email client but also could be instant messaging such as SMS/MMS/RCS or WhatsApp, etc. Disclosed is a system that manages a delay setting in a messaging application. The delay period, termed as an "ohnosecond", is computed for each outgoing message based on its properties, user activity, and anticipated significant events. These parameters can be at least in part a function of complexity of the email to be sent, the prior history of interactions (e.g. quick bursts), and the audience (recipient(s)). Embodiments can manually, semi-autonomously and/or autonomously adjust the ohnosecond setting for optimizing outbound message delivery.

Embodiments of the present disclosure can include implementation of the "ohnosecond" concept; combined with a variable delay mechanism in messaging applications. Embodiments can include dynamic adjustment of the delay period based on message properties, historical data, and user activities. Embodiments can include prediction and incorporation of future significant events or situations that can influence message delivery time. Embodiments can include optimizing human-computer interaction by allowing customization of message delivery delays.

Overall main inputs are starting data for embodiments and can include one, some or all of the following. Properties of the outgoing message, such as complexity, sentiment and audience. User activity data, like when the user shifts to a new atomic activity. Historical data, such as average round trip time of prior interactions. Predicted upcoming significant event(s) such as calendar data, meetings, times, etcetera.

Final yielding outputs for embodiments can include one, some or all of the following. Calculated ohnosecond value for each outgoing message. A tagged message ready to be sent after the ohnosecond delay. Defined "No later than" constraints for each message based on anticipated significant events. Continually updated ohnosecond settings based on new user activity data. Updated Knowledge Corpus specific to each and every User’s usage / system interactions.

Embodiments enable the application of artificial intelligence constructs, such as LLM (large language model), sentiment analysis, to the pervasive problem of sticking one’s foot in one’s mouth. This longstanding problem indicates the latent need for a non-deterministic ohnosecond to anchor deterministic computing processes to the real world.

Embodiments of this disclosure are useful because different people process information at different speeds. The introduction of the ohnosecond allows HCIs (human computer interfaces) to be configured for users of varying cognitive ability. Managing future near-term scheduled activities by the ohnosecond is a foundational concept with broad application across all industries.

According to one illustrative embodiment, a computer-implemented method for managing output message queues by an ohnosecond is provided. A number of processor units gather message data and main inputs at a customizable ohnosecond engine. The number of processor units provide the message data and an ohnosecond value from the customizable ohnosecond engine to a message transfer unit. The number of processor units, responsive to the ohnosecond value, send a delayed message comprising the message data from the message transfer unit to an external messaging program. According to other illustrative embodiments, a computer system and computer program product to manage output message queues by an ohnosecond are provided.

### BRIEF DESCRIPTION OF THE DRAWINGS

FIG. 1 is a block diagram of a computing environment in accordance with an illustrative embodiment;

FIG. 2 is a block diagram of an architecture to manage output message queues by the ohnosecond in accordance with an illustrative embodiment;

FIG. 3A is a block diagram of dataflow for managing output message queues by the ohnosecond in accordance with an illustrative embodiment;

FIG. 3B is a block diagram of dataflow for message analysis in accordance with an illustrative embodiment;

FIG. 4 is a block diagram of dataflow for ohnosecond analysis by layers in accordance with an illustrative embodiment;

FIG. 5 is a block diagram of dataflow for a customizable ohnosecond engine in accordance with an illustrative embodiment;

FIG. 6 is a block diagram of dataflow for a message transfer unit in accordance with an illustrative embodiment;

FIG. 7 is a block diagram of dataflow for an intelligent predictor in accordance with an illustrative embodiment;

FIG. 8 is a flow chart of a process in accordance with an illustrative embodiment;

FIG. 9 is a flow chart of an optional process step in accordance with an illustrative embodiment; and

FIG. 10 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

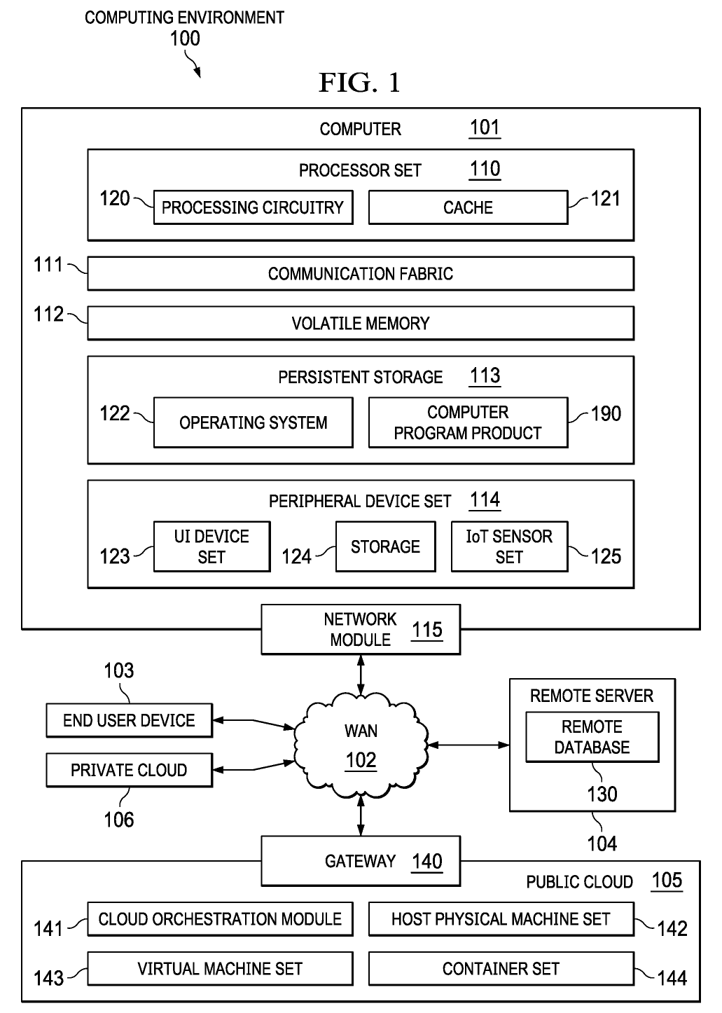

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as predicting, using an artificial intelligence enabled system, an incremental degradation of a battery of a transportation vehicle, calculating an equivalent carbon footprint, calculating an equivalent carbon footprint tax, and assessing the tax against the vehicle. Embodiments of this disclosure can be embodied in computer program product 190. In addition to computer program product 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and computer program product 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile sequestering device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in computer program product 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in computer program product 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of parameters” is one or more parameters. As another example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

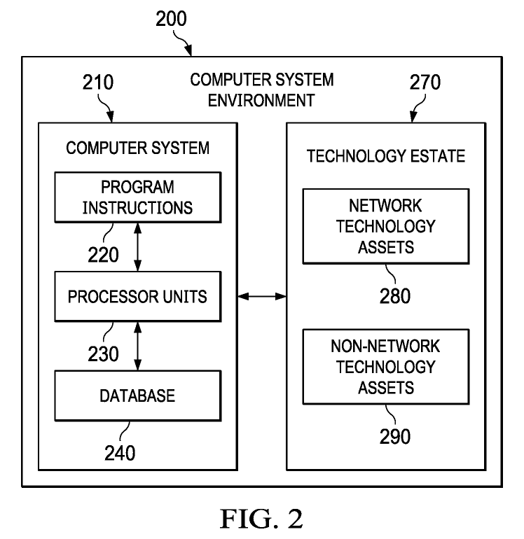

With reference now to FIG. 2, a block diagram of a computer system environment 200 is depicted in accordance with an illustrative embodiment. In this illustrative example, computer system environment 200 includes components that can be implemented in hardware such as the hardware shown in computing environment 100 in FIG. 1.

Computer system environment 200 includes computer system 210. Computer system 210 includes program instructions 220. Computer system 210 includes processor units 230. Computer system 210 includes database 240. Program instructions 220, processor units 230 and database 240 interact with one another.

The computer system environment 200 also includes technology estate 270. Technology estate 270 includes network technology assets 280. Technology estate 270 includes non-network technology assets 290. Technology estate 270 interacts with computer system 210.

Program instructions 220 and database 240 may be deployed with and/or implemented using computer program product 190 in FIG. 1.

Program instructions 220 and database 240 can be implemented in software, hardware, firmware or a combination thereof. When software is used, the operations performed by program instructions 220 and database 240 can be implemented using program instructions 220 configured to run on hardware, such as processor units 230. When firmware is used, the operations performed by program instructions 220 and database 240 can be implemented in program instructions and data and stored in persistent memory to run on a processor unit. When hardware is employed, the hardware can include circuits that operate to perform the operations in program instructions 220 and database 240.

Computer system 210 is a physical hardware system and includes one or more data processing systems. When more than one data processing system is present in computer system 210, those data processing systems are in communication with each other using a communications medium. The communications medium can be a network. The data processing systems can be selected from at least one of a computer, a server computer, a tablet computer, or some other suitable data processing system.

As depicted, computer system 210 includes processor units 230 that are capable of executing program instructions 220 implementing processes in the illustrative examples. In other words, program instructions 220 are computer readable program instructions.

As used herein, a processor unit in processor units 230 is a hardware device and is comprised of hardware circuits such as those on an integrated circuit that respond to and process instructions and program code that operate a computer. A processor unit can be implemented using processor set 110 in FIG. 1. When processor units 230 execute program instructions 220 for a process, processor units 230 can be one or more processor units that are in the same computer or in different computers. In other words, the process can be distributed between processor units on the same or different computers in computer system 210.

Further, processor units 230 can be of the same type or different types of processor units. For example, the processor units 230 can be selected from at least one of a single core processor, a dual-core processor, a multi-processor core, a general-purpose central processing unit (CPU), a graphics processing unit (GPU), a digital signal processor (DSP), or some other type of processor unit.

Computer system 210 can be configured to perform at least one of the steps, operations, or actions described in the different illustrative examples using software, hardware, firmware or a combination thereof. As a result, computer system 210 operates as a special purpose computer system in which program instructions 220 and database 240 in computer system 210 enables identifying, by a number of processor units, a plurality of infrastructure resources in a cloud environment; identifying, by the number of processor units, for each of the plurality of infrastructure resources, a set of attributes that influence carbon emission; identifying, by the number of processor units, for each member of the set of attributes, an attribute influence direction equal to be 0 when a lower attribute value corresponds to a lower or unchanged carbon emission and to be 1 when a higher attribute value corresponds to lower carbon emission; collecting, by the number of processor units, a set of time-series data for the plurality of infrastructure resources at a plurality of instants separated by substantially equal time intervals; evaluating, by the number of processor units, for each of the plurality of infrastructure resources at each of the plurality of instants, an infrastructure resource efficiency deficit score; ordering in descending rank, by the number of processor units, the infrastructure resource efficiency deficit score for each of the plurality of infrastructure resources at a particular time selected from the plurality of instants; and controlling at least one of the plurality of infrastructure resources based on the infrastructure resource efficiency deficit score of at least one of the plurality of infrastructure resources. In particular, program instructions 220 and database 240 transforms computer system 210 into a special purpose computer system as compared to currently available general computer systems that do not have program instructions 220 and database 240 because of the special purpose steps enabled by program instructions 220 and database 240.

In the illustrative example, the use of program instructions 220 and database 240 in computer system 210 integrates processes into a practical application for controlling at least one of network technology assets 280 and/or non-network technology assets 290 that can manage output message queues by the ohnosecond. In other words, program instructions 220 and database 240 in computer system 210 are directed to a practical application of processes integrated into computer system 210 that controls at least one of network technology assets 280 and/or non-network technology assets 290 that can manage output message queues by the ohnosecond.

The illustration of computer system 210 and computer system environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

In one embodiment, the system which in this case is a messaging application has a static setting for the length of time of an ohnosecond, for example 10 seconds. The method computes the number of ohnoseconds that is appropriate for the outgoing message, and tags the message accordingly. The system then begins delivery of the message after the ohnoseconds have elapsed. The calculation of the number of ohnoseconds is done based on the message properties such as complexity, and/or audience. The number of ohnoseconds is further refined from the properties of a group of messages such as typical round trip time of the prior interactions. Another refinement to the number of ohnoseconds comes from analysis of the operator’s activity, aimed at detecting when the operator has switched context to a new output-emitting activity, such as beginning composing a new message, versus an input-processing activity such as reading another incoming message or perceived idleness. As a result, messages would go out with a delay that is a multiple of 10-seconds, per the sample mapping above.

In another embodiment, the value of the ohnosecond is variable and managed independently from the messaging program by the operating system. The value of the ohnosecond is changed based on systemic inputs such as time of day –business versus non-business hours, perceived cognitive load on the user –working a Sev1, or even location –at the office versus on a business trip. In such an embodiment the messages would go out on delay of a number of statutory seconds that is established when the message was scheduled for delivery. That is to say that the delivery delay does not change in response to a change in the value of the ohnosecond while in the outbox.

In another embodiment, the point in time when a message is to be delivered is bound to a “no later than” constraint. Such a constraint is calculated by predicted upcoming significant events, such as having to enable Airplane Mode for the scheduled trans-Pacific flight, which would cause the message to be delivered at arrival several hours later.

In another embodiment, a system manages a delay setting in a messaging application. The delay period, termed as an "ohnosecond", is computed for each outgoing message based on its properties, user activity, and anticipated significant events. The system autonomously adjusts the ohnosecond setting for optimizing outbound message delivery.

Embodiments can include contextualization of ohnosecond, for managing the processing of an outbound/outbox queue. Further, a mechanism for determining the delay setting of outgoing messages in a messaging application, said delay, termed as an 'ohnosecond', is then tweaked based on properties of the outgoing message which includes, but is not limited to, complexity, sentiment, audience, and user activities; altering said ohnosecond according to properties of prior communications providing a context-driven determination of the ohnosecond value.

Embodiments can include contextualization of the ohnosecond based on single message properties. Embodiments can include contextualization of the ohnosecond based on message thread properties. Embodiments can include contextualization of the ohnosecond based on environmental conditions external to the messaging system.

Embodiments can include model leveraging artificial intelligence (AI) methods that utilize the user's historical data and activity logs, said model to influence the computation of the ‘ohnosecond’ value; leveraging machine learning techniques including but not limited to decision trees, random forest or gradient boosting algorithms to predict a suitable ‘ohnosecond’ value, thereby refining the determination of the ‘ohnosecond’ based on learning from historical context and user activity.

Embodiments can include an apparatus that anticipates future significant events or constraints, said anticipation is achieved using machine learning algorithms including, but not limited to, LSTM (Long Short-Term Memory), to ascertain potential situations which may impinge on message delivery; formulating a 'no-later-than' constraint for the messages based on the anticipated events, thereby ensuring that the messages are sent in a timely manner even in the presence of anticipated constraints.

For some embodiments, an “undo feasibility and difficulty” (UFAD) scoring model can be implemented that utilizes user and crowdsourced historical data to determine how easily a sequence of one or more commands that the user is attempting to process can be reverted to the previous state. Calculating this score can take into account one, some or all of the following factors.

Calculating the UFAD score can take into account command reversibility determination. Some commands are easily inherently reversible while others would require customized processes to reverse their effects.

Calculating the UFAD score can take into account data persistence. Do the commands modify data or system state persistently?

Calculating the UFAD score can take into account complexity of commands. Depending on the complexity and interdependencies of commands, there may be cascading effects that significantly make reverting more difficult.

Calculating the UFAD score can take into account time and effort required. For instance, there can be a calculation of time and effort required to manually re-create the contents. The total time user worked in generating the initial content might be used to derive this estimate.

Calculating the UFAD score can take into account availability of backups or snapshots. For example, there can be a determination of whether there were recent tested backups of the data and the data deltas between the backups and the current state.

Calculating the UFAD score can take into account documentation and logging considerations. For instance, there can be a determination of whether the commands being executed are well-documented and have a historical factor of easy undo or not as well as determining whether there are logs or audit trails available that can assist in the analysis and implementation of a manual revert process.

Calculating the UFAD score can take into account user expertise and familiarity. For example there can be a determination if a user has historically successfully reverted data using the commands determined.

The UFAD score may be on a scale of 0 to 100 where 0 may represent unfeasible and impossibly difficult to revert, whereby 100 would be easy undo with a single undo command. Lower UFAD scores will generate higher ohnosecond values that are directly related to the difficulty of reverting. In some embodiments, the user may be able to decrease the ohnosecond value by answering a questionnaire that acknowledges their awareness of all the system calculated risks mentioned above.

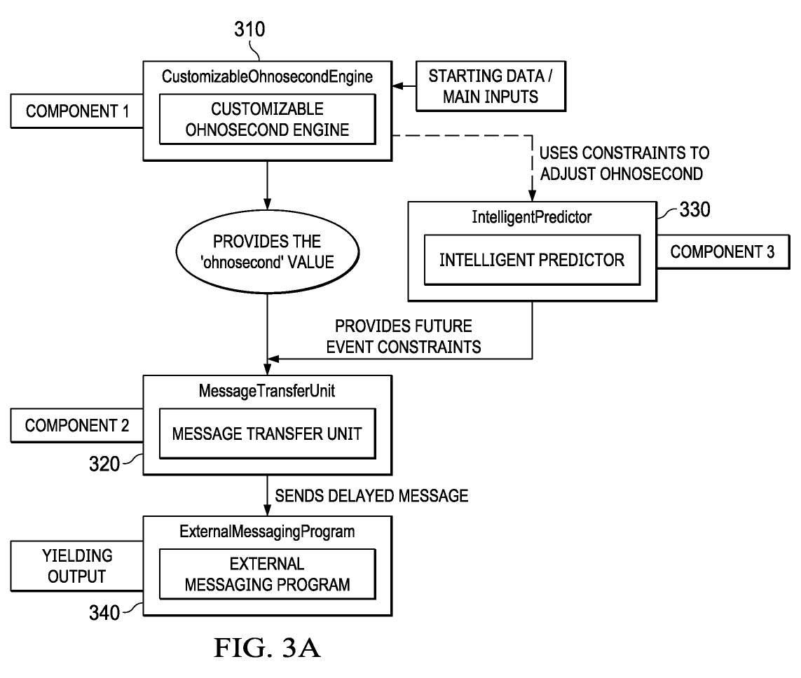

Turning next to FIG. 3A, in this illustrated example, a block diagram of dataflow for managing output message queues by the ohnosecond is shown. This is an intelligent delay system for messaging applications.

Customizable Ohnosecond Engine 310 as a subsystem uses various factors like message complexity, audience, historical context, and user activity to dynamically configure the "ohnosecond" or delay before messages are sent. Customizable Ohnosecond engine 310 interacts with the other components by adjusting their functionality based on the calculated ohnosecond. It sends the final ohnosecond value to the Message Transfer Unit 320 and directly influences the timing of when messages are sent.

Message Transfer Unit 320 as a subsystem component oversees actual message delivery. It receives the ohnosecond value from the Customizable Ohnosecond Engine 310 and holds messages for the prescribed time in an outgoing queue before sending. Message Transfer Unit 320 interacts with the Customizable Ohnosecond Engine 310 by using its ohnosecond value to adjust the delivery of messages, and with the Intelligent Predictor 330 by understanding predicted significant events and adjusting message sending times accordingly.

Intelligent Predictor 330 as a subsystem seeks to predict significant future events that may affect message delivery (e.g., transitioning to airplane mode), deriving a "no later than" constraint for each message. Intelligent Predictor 330 interacts with the other components by influencing the Customizable Ohnosecond Engine's configuration of the ohnosecond delay and, optionally, the Message Transfer Unit's decision on when to send messages based on defined constraints. This unit ensures messages are sent in consideration of potential significant events.

Message Transfer Unit 320 sends delayed message to External Messaging Program 340 for delivery thus yielding output.

Turning next to FIG. 3B, in this illustrated example, a block diagram of dataflow in the customizable ohnosecond engine for message analysis, user activity tracking, and historical context analysis is shown. Outgoing messages can be categorized as daily activity Group A 350 or otherwise Group B 360.

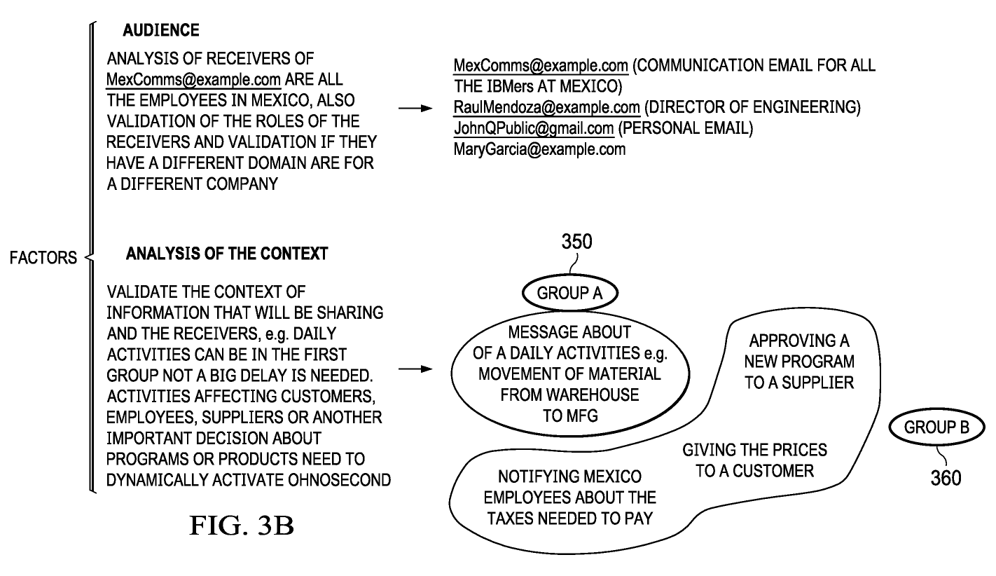

Turning next to FIG. 4, in this illustrated example, block diagram 400 of dataflow for ohnosecond analysis is shown. Ohnosecond calculation can be based on ohnosecond analysis by layers 410. The system can use the above described dynamic factors to calculate a suitable ohnosecond for a given message. In addition, the analysis can include a first layer based on receivers 420 and a second layer of content analysis 430. Generally, the more complex the message and the user's context, the longer the delay before sending. In this example, the calculated ohnosecond is a multiple of a base ohnosecond, say 10 seconds. The calculated ohnosecond can be parameter driven, for example. The calculation can be executed in layers that consider different aspects such as receivers, qty, roles, external companies, analysis of the context, and impact of the context. Then the system can create groups based on the impact of the context. An example of a low group would be a training session. Examples of a high group would be revenue, customer, program or project.

The delay of each layer can be set up by the user or the delay can be set up in a random by way of the system, for example if Jeremy is trying to send out an email, the mechanism will execute an analysis of the first layer in the qty ≥10 (5 seconds) and his email is a high level (5 seconds) and it is for an external company (10 seconds). Then the mechanism will move to the next layer, which is the analysis of the context which is an operation context for a new program (5 seconds) and the impact is high (10 seconds) because it is for a customer decision. So, the ohnosecond for this particular email could be 35 seconds. The calculated ohnosecond is tagged along with the message and directed towards the hello welcome hall message transfer unit as output.

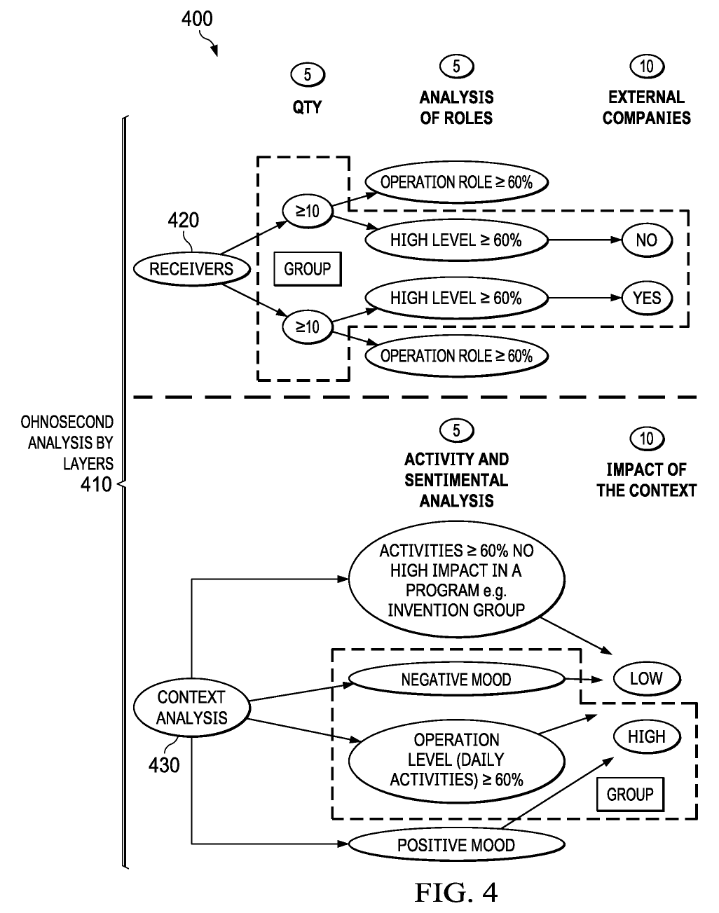

Turning next to FIG. 5, in this illustrated example, a block diagram 500 of dataflow for a customizable ohnosecond engine 310 in accordance with an illustrative embodiment is shown. An external data source 510 provides message data 512. The external data source 510 also provides user activity data 514 and historical data 516.

Message Analysis 520 can include the following elements. Upon receiving an outgoing message, the component analyzes the message to calculate its complexity. The complexity is decided based on factors like length of the message, number of recipients, and sentiment of the content. Applications like Natural Language Processing (NLP) and Text Mining can be used to analyze the content and sentiment.

User Activity Tracking 530 can include the following elements. The engine monitors the user's activity to understand their context. Activities like input-processing activity or transition to a new output-emitting activity are tracked. For example, an algorithm can be designed to detect when a user starts composing a new message or starts reading an incoming message after sending an outgoing one.

Historical Context Analysis 540 can include the following elements. The system uses historical data to make more informed decisions. For example, the round-trip time of prior interactions with the recipient(s) will be considered, along with the past instances of the user requiring “to undo” message sending.

After historical context analysis 540 historical data proceeds to ohnosecond calculation 550. The ohnosecond calculation 550 provides the output of customizable ohnosecond engine 310.

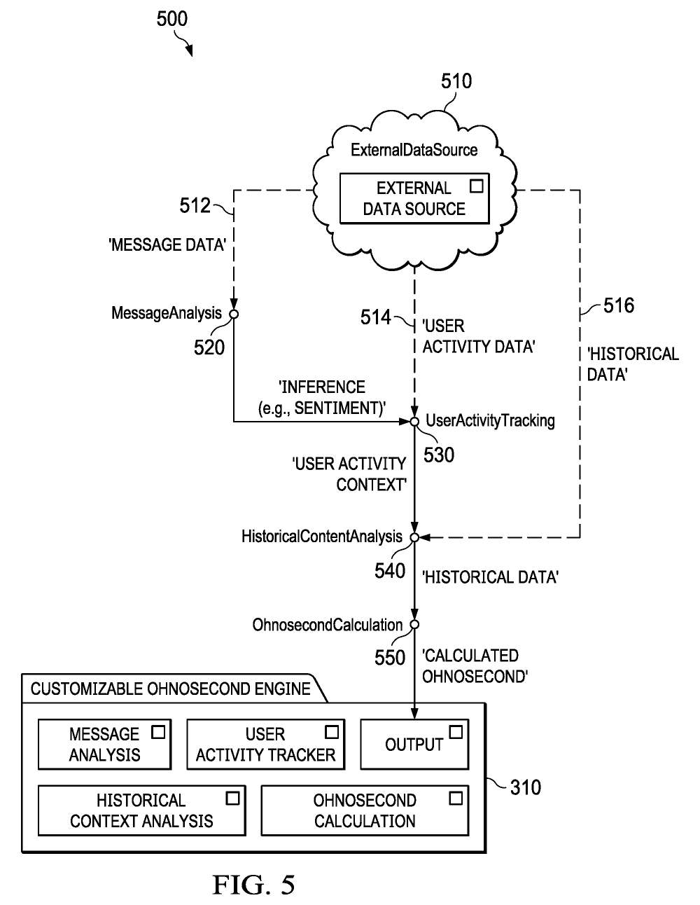

Turning next to FIG. 6, in this illustrated example, a block diagram of dataflow for a message transfer unit is shown. Message transfer unit 320 includes message reception 610. Initially, the Message Transfer Unit (MTU) receives the ready-to-send message along with the attached ohnosecond value from the Customizable Ohnosecond Engine 310. The message is not sent immediately but kept in the outbound queue.

Message transfer unit 320 includes ‘Ohnosecond’ Adherence 620 which is basis for usage. The MTU adheres to the ohnosecond value, implementing a delay before the message delivery. This delay acts as a buffer period, allowing the messaging system to retract or edit the message if needed.

Message transfer unit 320 includes Queuing Management 630. The MTU effectively manages the queue of outgoing messages, ensuring that the delivery timing of each message respects the calculated ohnosecond value.

Message transfer unit 320 includes Event Anticipation 640. The MTU interacts with the Intelligent Predictor 330 to get the constraints based on predicted significant future events.

Message transfer unit 320 includes Message Release 650. Post the fulfillment of the ohnosecond delay, the MTU releases the message to the External Messaging Program 340 for delivery.

Network Protocols: The Message Transfer Unit 320 will leverage Network Protocols such as SMTP for email delivery or MM3 for MMS. The decision on which protocol to use will largely depend on the type of message being sent.

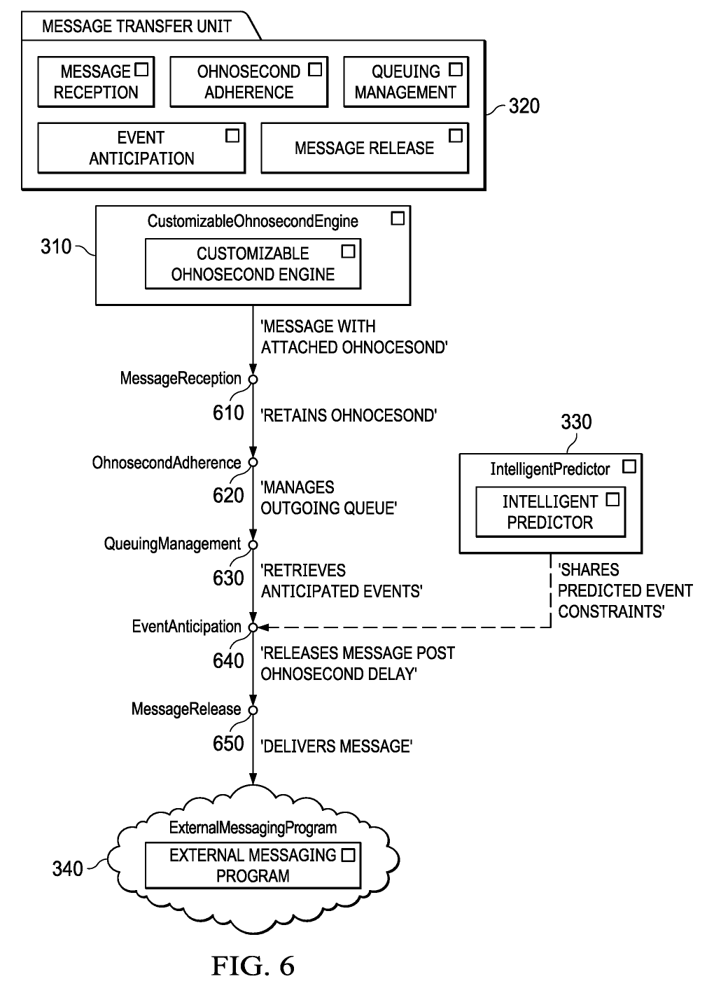

Turning next to FIG. 7, in this illustrated example, a block diagram of dataflow for intelligent predictor 330 is shown. Intelligent Predictor 330 includes event anticipation 710. The Intelligent Predictor 330 anticipates future events or situations that can significantly impact message delivery time. Situations such as expected transition to airplane mode or user's scheduled meetings are considered or taken into account here.

Intelligent Predictor 330 includes constraint formulation 720. The Predictor formulates the constraints depending on the anticipated events. This is referred to as the "no later than" constraint.

Intelligent Predictor 330 includes user activity analysis 730. Based on the user's past activity logs and behavior patterns, the predictor refines the anticipated events. Machine learning models and algorithms can be used to learn from past events and derive behavior patterns.

Intelligent Predictor 330 includes constraint delivery 740. The constraints are then passed down to the Customizable Ohnosecond Engine 310 and the Message Transfer Unit 320. These constraints will help finetune the ohnosecond value and message delivery timings respectively.

Intelligent Predictor 330 includes continuous learning 750 and updating. The Intelligent Predictor 330 is designed to continuously learn and update its anticipated events and constraints repository based on new user activity data.

Intelligent Predictor 330 can optionally include machine learning. Algorithms like LSTM (Long Short-Term Memory) can be employed for learning of sequential data to anticipate future events efficiently. Reinforcement Learning can also be helpful for the system to learn and improve from its past decisions. Utilizing API(s): User activity logs can be fetched via APIs provided by operating systems or applications. These will provide the raw data for the predictor to learn and formulate constraints.

Intelligent Predictor 330 can optionally include considering the following IT standards. Privacy and data usage standards must be adhered to while accessing and making use of user logs. Necessary permissions should be sought and GDPR data-based regulations should be followed – for example.

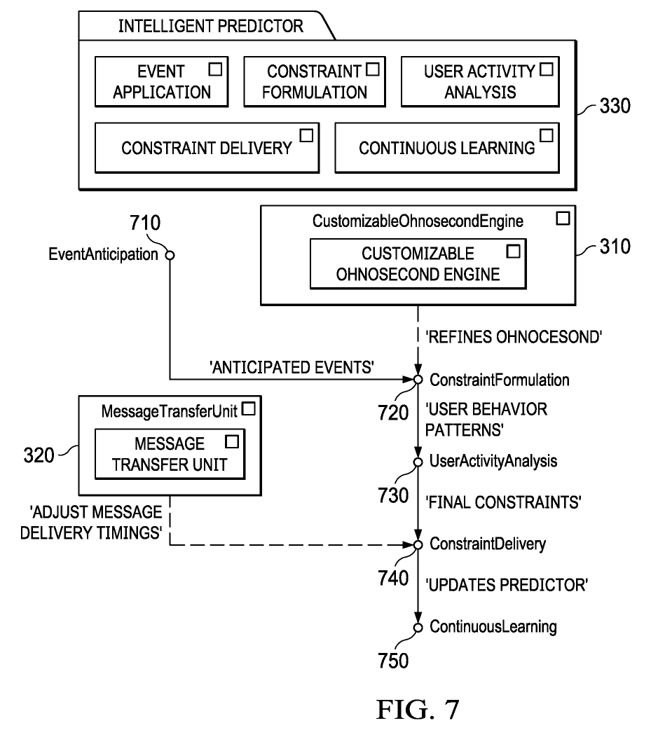

Turning next to FIG. 8, in this illustrated example, a computer implemented method 800 enables an end user device to control an ohnosecond value that controls sending, transferring, transmitting a delayed message. Block 810 includes gathering, by a number of processor units, message data and main inputs at a customizable ohnosecond engine. Block 820 includes providing, by the number of processor units, the message data and an ohnosecond value from the customizable ohnosecond engine to a message transfer unit. Block 830 includes responsive to the ohnosecond value, sending, by the number of processor units, a delayed message comprising the message data from the message transfer unit to an external messaging program.

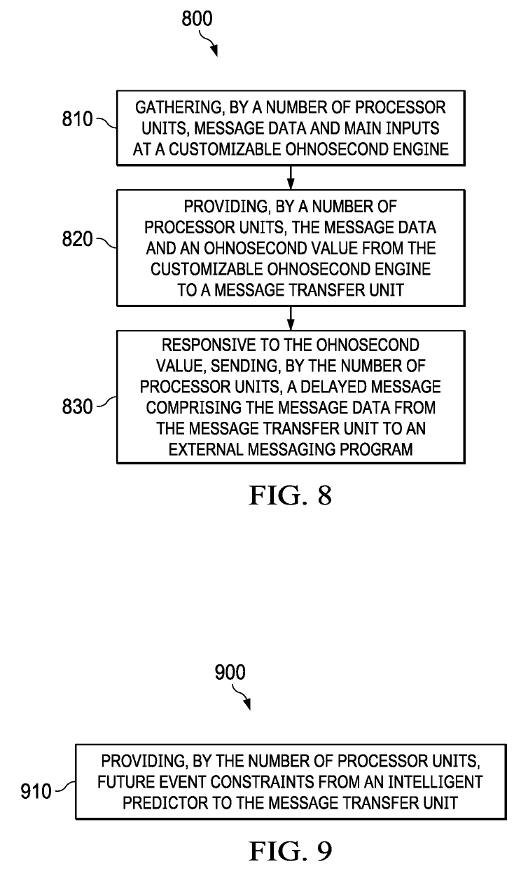

Turning now to FIG. 9, in this illustrated example, an optional computer implemented step 900 enables providing future event constraints from an intelligent predictor that further control sending, transferring and/or transmitting the delayed message. Block 910 includes providing, by the number of processor units, future event constraints from an intelligent predictor to the message transfer unit.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

In certain alternative embodiments, the invention can apply ohnosecond factor analysis and delay to one, some or all command(s) issued within the system and the system will determine and set the ohnosecond for various commands or sequences of commands separately depending on the UFAD score explained above. For these alternative embodiments, the implementation can be as follows.

First, end users opt into invention terms of service. As the user works on various files on the system, the system will record an accumulated time metadata on the files to determine the total user work effort on the file. This time metadata will also be later used in determining the total impact of commands that are targeted or may indirectly impact a particular file. As the user initiates various commands on the system, the commands are analyzed before processing to determine the UFAD score. Once UFAD score is determined, the system will set the ohnosecond value delay for the processing of the particular commands that are pending and show a countdown timer until their execution. For example, when a user deletes three old versions of a file for which there are newer versions available, the ohnosecond delay might be 5 seconds, and it may allow the user to continue other work while the countdown happens in the background. As another example, when a user is trying to delete a whole directory branch which may include a few subdirectories deep in a particular file that has a high time investment metadata and which does not have any other backups in the system, the ohnosecond value might be set to 5 minutes, and the user may only be able to background the countdown task by answering a questionnaire verifying knowledge and acceptance of risk of the particular command.

A practical application of embodiments of the present disclosure that has value within the technological arts is enabling an end user device to control an ohnosecond value that controls sending, transferring, transmitting a delayed message. Another practical application of embodiments of this disclosure that has value with the technological arts is providing future event constraints from an intelligent predictor that further control sending, transferring and/or transmitting the delayed message. There are virtually innumerable uses for embodiments of the present disclosure, all of which need not be detailed here.

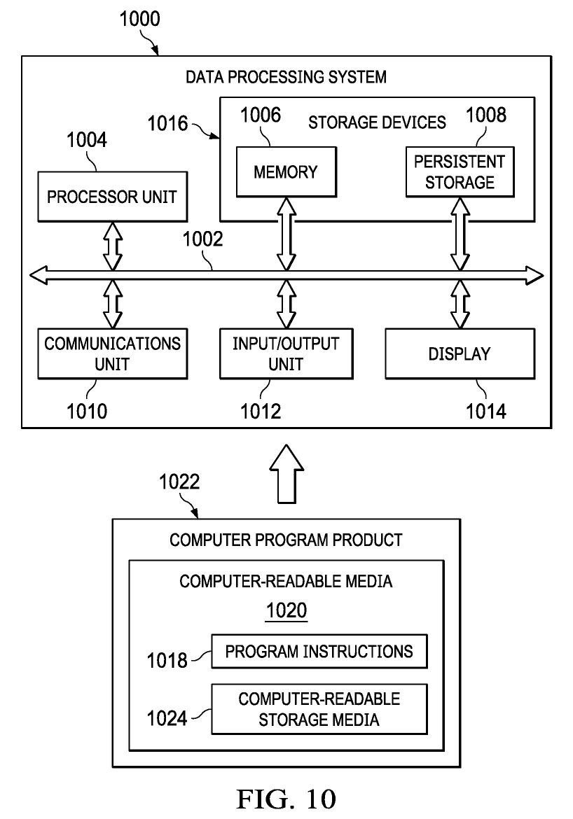

Turning now to FIG. 10, a block diagram of a data processing system is depicted in accordance with an illustrative embodiment. Data processing system 1000 can be used to implement computers and computing devices in computing environment 100 in FIG. 1. Data processing system 1000 can also be used to implement computer system 212 in FIG. 2. In this illustrative example, data processing system 1000 includes communications framework 1002, which provides communications between processor unit 1004, memory 1006, persistent storage 1008, communications unit 1010, input/output (I/O) unit 1012, and display 1014. In this example, communications framework 1002 takes the form of a bus system.

Processor unit 1004 serves to execute instructions for software that can be loaded into memory 1006. Processor unit 1004 includes one or more processors. For example, processor unit 1004 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1004 can be implemented using one or more heterogeneous processor systems in which a main processor is present with secondary processors on a single chip. As another illustrative example, processor unit 1004 can be a symmetric multi-processor system containing multiple processors of the same type on a single chip.

Memory 1006 and persistent storage 1008 are examples of storage devices 1016. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1016 may also be referred to as computer readable storage devices in these illustrative examples. Memory 1006, in these examples, can be, for example, a random-access memory or any other suitable volatile or non-volatile storage device. Persistent storage 1008 may take various forms, depending on the particular implementation.

For example, persistent storage 1008 may contain one or more components or devices. For example, persistent storage 1008 can be a hard drive, a solid-state drive (SSD), a flash memory, a rewritable optical disk, a rewritable magnetic tape, or some combination of the above. The media used by persistent storage 1008 also can be removable. For example, a removable hard drive can be used for persistent storage 1008.

Communications unit 1010, in these illustrative examples, provides for communications with other data processing systems or devices. In these illustrative examples, communications unit 1010 is a network interface card.

Input/output unit 1012 allows for input and output of data with other devices that can be connected to data processing system 1000. For example, input/output unit 1012 may provide a connection for user input through at least one of a keyboard, a mouse, or some other suitable input device. Further, input/output unit 1012 may send output to a printer. Display 1014 provides a mechanism to display information to a user.

Instructions for at least one of the operating system, applications, or programs can be located in storage devices 1016, which are in communication with processor unit 1004 through communications framework 1002. The processes of the different embodiments can be performed by processor unit 1004 using computer-implemented instructions, which may be located in a memory, such as memory 1006.

These instructions are referred to as program instructions, computer usable program instructions, or computer readable program instructions that can be read and executed by a processor in processor unit 1004. The program instructions in the different embodiments can be embodied on different physical or computer readable storage media, such as memory 1006 or persistent storage 1008.

Program instructions 1018 are located in a functional form on computer-readable media 1020 that is selectively removable and can be loaded onto or transferred to data processing system 1000 for execution by processor unit 1004. Program instructions 1018 and computer readable media 1020 form computer program product 1022 in these illustrative examples. In the illustrative example, computer readable media 1020 is computer-readable storage media 1024.

Computer readable storage media 1024 is a physical or tangible storage device used to store program instructions 1018 rather than a medium that propagates or transmits program instructions 1018. Computer readable storage media 1024, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1018 can be transferred to data processing system 1000 using a computer readable signal media. The computer readable signal media are signals and can be, for example, a propagated data signal containing program instructions 1018. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1020 can be singular or plural. For example, program instructions 1018 can be located in computer readable media 1020 in the form of a single storage device or system. In another example, program instructions 1018 can be located in computer readable media 1020 that is distributed in multiple data processing systems. In other words, some instructions in program instructions 1018 can be located in one data processing system while other instructions in program instructions 1018 can be located in one data processing system. For example, a portion of program instructions 1018 can be located in computer readable media 1020 in a server computer while another portion of program instructions 1018 can be located in computer readable media 1020 located in a set of client computers.

The different components illustrated for data processing system 1000 are not meant to provide architectural limitations to the manner in which different embodiments can be implemented. In some illustrative examples, one or more of the components may be incorporated in or otherwise form a portion of, another component. For example, memory 1006, or portions thereof, may be incorporated in processor unit 1004 in some illustrative examples. The different illustrative embodiments can be implemented in a data processing system including components in addition to or in place of those illustrated for data processing system 1000. Other components shown in FIG. 10 can be varied from the illustrative examples shown. The different embodiments can be implemented using any hardware device or system capable of running program instructions 1018.

Thus, illustrative embodiments of the present disclosure provide a computer-implemented method, computer system, and computer program product for repositioning a sequestering device in a data center. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method comprising:
gathering, by a number of processor units, message data and main inputs at a customizable ohnosecond engine;
providing, by the number of processor units, the message data and an ohnosecond value from the customizable ohnosecond engine to a message transfer unit; and
responsive to the ohnosecond value, sending, by the number of processor units, a delayed message comprising the message data from the message transfer unit to an external messaging program.

2. The computer implemented method of claim 1, wherein the customizable ohnosecond engine is controlled by an end user device.

3. The computer implemented method of claim 2, wherein the customizable ohnosecond engine is located within the end user device.

4. The computer implemented method of claim 1, wherein the ohnosecond value is a constant time period, the delayed message is sent after a duration comprising a multiple of the constant time period, and the multiple is controlled by the customizable ohnosecond engine.

5. The computer implemented method of claim 1, wherein the ohnosecond value is a variable time period controlled by the customizable ohnosecond engine and the delayed message is sent after a duration comprising the variable time period.

6. The computer implemented method of claim 1, further comprising
providing, by the number of processor units, at least one future event constraint from an intelligent predictor to the message transfer unit,
wherein the delayed message is sent in response to the at least one future event constraint.

7. The computer implemented method of claim 6, wherein the at least one future event constraint comprises a to be delivered no later than constraint.

8. A computer system comprising:
a processor set;
a set of one or more computer readable storage media;
program instructions, collectively stored in the set of one or more storage media, for causing the processor set to perform the following computer operations:
gathering, by a number of processor units, message data and main inputs at a customizable ohnosecond engine;
providing, by the number of processor units, the message data and an ohnosecond value from the customizable ohnosecond engine to a message transfer unit; and
responsive to the ohnosecond value, sending, by the number of processor units, a delayed message comprising the message data from the message transfer unit to an external messaging program.

9. The computer system of claim 8, wherein the program instructions cause the processor set to perform the following computer operations:
wherein the customizable ohnosecond engine is controlled by an end user device.

10. The computer system of claim 9, wherein the program instructions cause the processor set to perform the following computer operations:
wherein the customizable ohnosecond engine is located within the end user device.

11. The computer system of claim 8, wherein the program instructions cause the processor set to perform the following computer operations:
wherein the ohnosecond value is a constant time period, the delayed message is sent after a duration comprising a multiple of the constant time period, and the multiple is controlled by the customizable ohnosecond engine.

12. The computer system of claim 8, wherein the program instructions cause the processor set to perform the following computer operations:
wherein the ohnosecond value is a variable time period controlled by the customizable ohnosecond engine and the delayed message is sent after a duration comprising the variable time period.

13. The computer system of claim 8, wherein the program instructions cause the processor set to perform the following computer operations:
providing, by the number of processor units, at least one future event constraint from an intelligent predictor to the message transfer unit,
wherein the delayed message is sent in response to the at least one future event constraint.

14. The computer system of claim 13, wherein the program instructions cause the processor set to perform the following computer operations:
wherein the at least one future event constraint comprises a to be delivered no later than constraint.

15. A computer program product comprising:
a set of one or more computer-readable storage media; and
program instructions, collectively stored in the set of one or more storage media, for causing a processor set to perform the following computer operations:
gathering, by a number of processor units, message data and main inputs at a customizable ohnosecond engine;
providing, by the number of processor units, the message data and an ohnosecond value from the customizable ohnosecond engine to a message transfer unit; and
responsive to the ohnosecond value, sending, by the number of processor units, a delayed message comprising the message data from the message transfer unit to an external messaging program.

16. The computer program product of claim 15, wherein the program instructions cause the processor set to perform the following computer operations:
wherein the customizable ohnosecond engine is controlled by an end user device.

17. The computer program product of claim 16, wherein the program instructions cause the processor set to perform the following computer operations:
wherein the customizable ohnosecond engine is located within the end user device.

18. The computer program product of claim 15, wherein the program instructions cause the processor set to perform the following computer operations:
wherein the ohnosecond value is a constant time period, the delayed message is sent after a duration comprising a multiple of the constant time period, and the multiple is controlled by the customizable ohnosecond engine.

19. The computer program product of claim 15, wherein the program instructions cause the processor set to perform the following computer operations:
wherein the ohnosecond value is a variable time period controlled by the customizable ohnosecond engine and the delayed message is sent after a duration comprising the variable time period.

20. The computer program product of claim 15, wherein the program instructions cause the processor set to perform the following computer operations:
providing, by the number of processor units, at least one future event constraint from an intelligent predictor to the message transfer unit,
wherein the delayed message is sent in response to the at least one future event constraint.
